(19) United States
(12) Patent Application Publication
(10) Pub. No.: US 2025/0290550 A1
(43) Pub. Date: Sep. 18, 2025

(54) LOCKING MECHANISM

(71) Applicant: TEREX SOUTH DAKOTA, INC., Watertown, SD (US)

(72) Inventors: Abin PETER, Bengaluru (IN); Prathap MURALIDHARA, Bengaluru (IN); Sendil MUTHUSWAMY, Bengaluru (IN); Ankith RAVISHANKAR, Bengaluru (IN); Yogesh RJ, Bengaluru (IN)

(73) Assignee: TEREX SOUTH DAKOTA, INC., Watertown, SD (US)

(21) Appl. No.: 18/605,327

(22) Filed: Mar. 14, 2024

(51) Int. Cl. F16D 63/00; F16D 121/14; F16D 125/28

(52) U.S. Cl. CPC F16D 63/004; F16D 2121/14; F16D 2125/28

(57) ABSTRACT

A locking mechanism according to the disclosure may include a lock member having multiple projections, and first and second engaging members that are each pivotable with respect to the lock member. The first engaging member is engageable with the lock member to inhibit relative rotation between the lock member and the engaging members in a first rotation direction, and the second engaging member is engageable with the lock member to inhibit relative rotation between the lock member and the engaging members in a second rotation direction opposite the first rotation direction. The first and second engaging members may be simultaneously engageable with the lock member to provide a locked condition of the locking mechanism in which the first and second engaging members are each engaged with a respective one of the projections.

### TECHNICAL FIELD

The disclosure relates to a locking mechanism.

### BACKGROUND

Example brake systems are disclosed in U.S. Pat. No. 9,657,791 B2 and U.S. Patent Application Publication No. 2021/0213914 A1.

### SUMMARY

A locking mechanism according to the disclosure may include a lock member having multiple projections, and first and second engaging members that are each pivotable with respect to the lock member. The first engaging member is engageable with the lock member to inhibit relative rotation between the lock member and the engaging members in a first rotation direction, and the second engaging member is engageable with the lock member to inhibit relative rotation between the lock member and the engaging members in a second rotation direction opposite the first rotation direction. The first and second engaging members may be simultaneously engageable with the lock member to provide a locked condition of the locking mechanism in which the first and second engaging members are each engaged with a respective one of the projections.

While exemplary embodiments are illustrated and disclosed, such disclosure should not be construed to limit the claims. It is anticipated that various modifications and alternative designs may be made without departing from the scope of the disclosure.

### BRIEF DESCRIPTION OF THE DRAWINGS

FIG. 1 is a schematic view of a locking mechanism according to the disclosure shown in a first position;

FIG. 2 is a schematic view of the locking mechanism shown in a second position;

FIG. 3 is an end view of an example lift device or lift including one or more locking mechanisms according to the disclosure;

FIG. 4 is a perspective view of the lift of FIG. 3 including a support member arrangement shown in a lowered position, and a drive system for moving the support member arrangement;

FIG. 5 is a perspective view of the lift with the support member arrangement shown in a raised position; and

FIG. 6 is a fragmentary cross-sectional view of the lift showing two locking mechanisms, according to the disclosure, that are each associated with an axle of the lift.

### DETAILED DESCRIPTION

As required, detailed embodiments are disclosed herein. However, it is to be understood that the disclosed embodiments are merely exemplary, and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that terms such as “includes,” “including,” “comprises” and/or “comprising” specify the presence of stated features, integers, steps, operations, elements, and/or components, but do not preclude the presence or addition of one or more other features, integers, steps, operations, elements, components, and/or groups thereof.

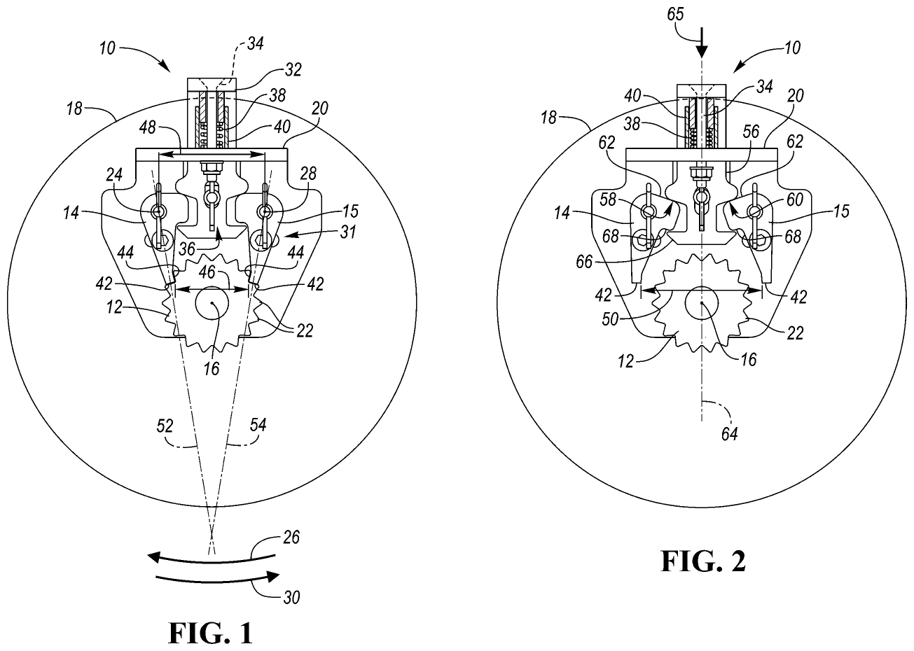

FIGS. 1 and 2 show a locking mechanism 10 according to the disclosure which may be used to lock relative movement between two components. For example, the locking mechanism 10 may include one portion attached to a movable component (e.g., rotatable component) and another portion attached to a fixed component, and the portions of the locking mechanism 10 may be lockable together to inhibit or prevent relative movement of the two components.

In the embodiment shown in FIGS. 1 and 2, the locking mechanism 10 includes a first portion, such as lock member 12, and a second portion, such as first and second engaging members 14 and 15, that are engageable with the lock member 12 to inhibit or prevent relative rotation between the lock member 12 and the engaging members 14 and 15. In this embodiment, the lock member 12 is a rotatable member, such as a gear, ratchet wheel, etc., that is rotatable about an axis 16 (which is located at a center of the lock member 12 in the embodiment shown in FIGS. 1 and 2), and the engaging members 14 and 15 are pivotable engaging members, such a pawls, bars, arms, etc. Furthermore, the lock member 12 is associated with a rotatable member or element 18 so that the lock member 12 and the rotatable element 18 are rotatable together about the lock member axis 16. For example, the lock member 12 and the rotatable element 18 may be mounted on a common rotatable support, such as a shaft, axle, rod, etc., or the lock member 12 may be integrally formed with the rotatable element 18. The locking mechanism 10 may therefore be configured to inhibit or prevent rotation of the rotatable element 18 in this embodiment.

The rotatable element 18 may be any suitable rotatable element. For example, the rotatable element 18 may be a wheel of a mobile device or vehicle, such as a lift device or lift (e.g., aerial work platform) or any other suitable device or vehicle, or a rotatable actuator of such a lift (e.g., a wheel, disc, hand crank, lever arm, etc.) for raising and lowering a support member arrangement and/or work platform assembly of the lift. As another example, the rotatable element 18 may be any other rotatable element in any suitable application in which inhibiting or preventing rotational movement may be desirable.

In the illustrated embodiment, the engaging members 14 and 15 are pivotally mounted on a support member 20, such as a bracket, chassis, or any suitable support body (e.g., rigid body), in any suitable manner, such as with pivot pins (e.g., dowel pins) and associated fasteners (e.g., cotter pins). Furthermore, the engaging members 14 and 15 are engageable with the rotatable member 12 to inhibit or prevent rotation of the lock member 12 in any direction, and the engaging members 14 and 15 are disengageable from the lock member 12 to allow rotation of the lock member 12 in any direction. More specifically, the engaging members 14 and 15 are configured to be engaged with projections or teeth 22 of the lock member 12 (which teeth 22 project outwardly from a main body of the lock member 12) when the locking mechanism 10 is in a closed or locked position, shown in FIG. 1, and the engaging members 14 and 15 are disengaged from the lock member 12 when the locking mechanism 10 is in an open or released position, shown in FIG. 2. The first engaging member 14 is pivotable about a first axis 24 and engageable with the lock member 12 (e.g., with one or more of the teeth 22 of the lock member 12) to inhibit or prevent rotation of the lock member 12 in a first rotation direction 26 (clockwise in the embodiment shown in FIG. 1), and the second engaging member 15 is pivotable about a second axis 28 and engageable with the lock member 12 (e.g., with one or more of the teeth 22 of the lock member 12) to inhibit or prevent rotation of the lock member 12 in a second rotation direction 30 (counter-clockwise in the embodiment shown in FIG. 1) opposite the first rotation direction 26. The engaging members 14 and 15 are also disengageable from the lock member 12, as shown in FIG. 2, to allow rotation of the lock member 12. The engaging members 14 and 15 are therefore configured to provide a locked condition of the locking mechanism 10, in which the lock member 12 is inhibited or prevented from rotating in either the first rotation direction 26 or the second rotation direction 30, and a released condition of the locking mechanism 10, in which the lock member 12 is able to rotate in either direction.

In addition, each engaging member 14, 15 may be connected to, or otherwise associated with, the support member 20 by a guide arrangement 31 that guides pivotal movement of the engaging member 14, 15, and may also limit pivotal movement of the engaging member 14, 15. For example, each guide arrangement 31 for each engaging member 14, 15 may include a projection, such as a bolt, rod, pin, etc., on one of the engaging member 14, 15 and the support member 20, and an elongated opening (e.g., arcuate-shaped opening), such as a slot, groove or channel, on the other of the engaging member 14, 15 and the support member 20 and that slidably receives the projection during pivotal movement of the engaging member 14, 15. In the illustrated embodiment, each engaging member 14, 15 includes a projection that extends from a main body of the engaging member 14, 15 and that is received in an arcuate-shaped opening formed in the support member 20.

The locking mechanism 10 further includes an actuation member or actuating member 32, such as a bar, rod, lever, arm, etc., that is operable to move the engaging members 14 and 15 from a closed or locked position, in which the engaging members 14 and 15 provide the locked condition of the locking mechanism 10, to an open or released position, in which the engaging members 14 and 15 provide the released condition of the locking mechanism 10. In that regard, the actuating member 32 may be movable between a first position, such as a locked position shown in FIG. 1, and a second position, such as an actuated position shown in FIG. 2, wherein the engaging members 14 and 15 are engageable with the lock member 12 to provide the locked condition of the locking mechanism 10 when the actuating member 32 is in the first position, and when the actuating member 32 is moved from the first position to the second position, the actuating member 32 causes the engaging members 14 and 15 to disengage the lock member 12 to provide the released condition of the locking mechanism 10. As explained below, the actuating member 32 may also be configured to move the engaging members 14 and 15 to the closed or locked position.

In the illustrated embodiment, the actuating member 32 is movably mounted on the support member 20. For example, the actuating member 32 may be mounted to the support member 20 with a fastener 34, such as a bolt, rod, etc., having a first end connected to a portion of the actuating member 32, such as an end (e.g., upper end in the embodiment shown in FIG. 1) of the actuating member 32, and a second end that extends through an opening in the support member 20 so that the fastener 34 is movable through the opening when the actuating member 32 moves between the first and second positions. In addition, or as an alternative, the actuating member 32 may be connected to, or otherwise associated with, the support member 20 by a guide arrangement 36 that guides movement of the actuating member 32 during movement between the first and second positions. For example, the guide arrangement 36 may include a projection, such as a bolt, rod, pin, etc., on one of the support member 20 and the actuating member 32, and an elongated opening, such as a slot, groove or channel, on the other of the support member 20 and the actuating member 32 and that slidably receives the projection during movement of the actuating member 32 between the first and second positions.

As shown in FIGS. 1 and 2, the locking mechanism 10 may also include a biasing member 38, such as a compression spring (e.g., helical spring or coil spring) or any other suitable spring, that urges the actuating member 32 toward the first position. In the illustrated embodiment, the biasing member 38 is positioned between the support member 20 and a portion (e.g., end) of the actuating member 32. For example, the biasing member 38 may be positioned around the fastener 34 and inside of, or at least partially inside of, a cylinder 40 having first and second portions (e.g., inner and outer cylindrical portions), wherein one portion of the cylinder 40 is movable with respect to the other portion when the actuating member 32 moves between the first and second positions.

With the above configuration, the engaging members 14 and 15 may simultaneously provide the locked condition of the locking mechanism 10. In that regard, each engaging member 14 and 15 may be engaged with a respective tooth 22 of the lock member 12 when the locking mechanism 10 is in the locked condition. For example, an end 42 of each engaging member 14 and 15 may be engaged with a side of a respective tooth 22 when the locking mechanism 10 is in the locked condition. In the illustrated embodiment, an end surface of the end 42 of each engaging member 14 and 15 is parallel with the side of the respective tooth 22 when the locking mechanism 10 is in the locked condition. A side portion 44 of each engaging member 14 and 15 proximate the end 42 (e.g., adjacent the end 42) may also be engaged with a side of another respective tooth 22 (e.g., a tooth 22 located adjacent the tooth 22 with which the end 42 is engaged) when the locking mechanism 10 is in the locked condition. In the illustrated embodiment, a side surface of the side portion 44 of each engaging member 14 and 15 is parallel with the side of the another respective tooth 22 when the locking mechanism 10 is in the locked condition. Furthermore, if the engaging members 14 and 15 are unable to sufficiently engage the lock member 12 and move to the locked position, due to a particular rotational position of the lock member 12 for example, tolerances may be selected to allow only a very small amount of rotational movement of the lock member 12 (e.g., in the range of 15° to 20°) before the engaging members 14 and 15 are able to move to the locked position to achieve the locked condition of the locking mechanism 10 and thereby instantaneously lock movement of the lock member 12 and the rotatable element 18.

Alternatively, the engaging members 14 and 15 may have any suitable configuration sufficient to engage the lock member 12. For example, the engaging members 14 and 15 may each have a curved or rounded end that is engageable with a respective tooth 22 or other feature of the lock member 12.

In addition, the locking mechanism 10 may be configured so that the engaging members 14 and 15 are self-locking when the engaging members 14 and 15 are in the locked position. As a result, absent movement of the actuating member 32 from the first position toward the second position, the engaging members 14 and 15 will remain in the locked position. For example, forces applied by the lock member 12 on the engaging members 14 and 15 may not cause the engaging members 14 and 15 to disengage the lock member 12. With such a configuration, the locking mechanism 10 may provide significant locking forces when in the locked condition.

Referring to FIG. 1, when the actuating member 32 is in the first position and the end 42 of each of the engaging members 14 and 15 is engaged with the lock member 12 (e.g., with a respective one of the teeth 22), the ends 42 may be spaced apart a first distance 46 that is smaller than a second distance 48 by which the first and second axes 24 and 28, respectively, are spaced apart. In addition, the engaging members 14 and 15 may be configured to rotate toward each other when the engaging members 14 and 15 move from the released position to the locked position, such that the ends 42 are closer together when the engaging members 14 and 15 are in the locked position as compared to when the engaging members 14 and 15 are in the released position. In other words, the first distance 46 is also smaller than a distance 50 (shown in FIG. 2) by which the ends 42 are spaced apart when the actuating member 32 is the second position.

Furthermore, in the illustrated embodiment, when the end 42 of the first engaging member 14 is engaged with the lock member 12 (e.g., with a respective tooth 22), a line 52 extending through the first axis 24 and the end 42 of the first engaging member 15 does not pass between the actuating member 32 and the lock member axis 16, as shown in FIG. 1. Likewise, when the end 42 of the second engaging member 15 is engaged with the lock member 12 (e.g., with a respective tooth 22), a line 54 extending through the second axis 28 and the end 42 of the second engaging member 15 does not pass between the actuating member 32 and the lock member axis 16. Instead, the lines 52 and 54 converge on a side of the lock member axis 16 opposite the actuating member 32.

Alternatively, the engaging members 14 and 15 and the lock member 12 may have any suitable configuration for cooperating with each other. For example, the lock member 12 may have a sufficiently large diameter such that the engaging members 14 and 15 are each angled outwardly with respect to each other when the engaging members 14 and 15 are engaged with the lock member 12.

The locking mechanism 10 may also be configured so that, when the locking mechanism 10 is in the locked condition and the actuating member 32 is in the first position, the actuating member 32 does not exert a force on the engaging members 14 and 15 for urging the engaging members 14 and 15 into engagement with the lock member 12. In that regard, because the engaging members 14 and 15 may be self-locking, the actuating member 32 may not be needed to assist in maintaining the locking mechanism 10 in the locked condition.

The actuating member 32 may be configured to efficiently and effectively move the engaging members 14 and 15 from the locked position, showing FIG. 1, to the released position, shown in FIG. 2. In the illustrated embodiment, the actuating member 32 has a main body 56 that extends between the first and second axes 24 and 28, respectively, of the first and second engaging members 14 and 15, respectively, and the main body 56 has first and second surfaces 58 and 60, respectively, disposed on opposite sides of the main body 56 that are engageable with the first and second engaging members 14 and 15, respectively, when the actuating member 32 moves from the first position, shown in FIG. 1, to the second position, shown in FIG. 2, to cause the first and second engaging members 14 and 15, respectively to disengage the lock member 12. In the illustrated embodiment, the first and second surfaces 58 and 60, respectively, are cam surfaces that are each engageable with a respective end 62 of a respective engaging member 14, 15, wherein the end 62 of each engaging member 14, 15 is opposite the end 42.

In the illustrated embodiment, the actuating member 32 also moves toward the lock member axis 16 when the actuating member 32 moves from the first position, shown in FIG. 1, to the second position, shown in FIG. 2. In that regard, as shown in FIGS. 1 and 2, the actuating member 32 is located closer to the lock member axis 16 when the actuating member 32 is in the second position, shown in FIG. 2, as compared to when the actuating member 32 is in the first position, shown in FIG. 1.

In addition, the actuating member 32 in the illustrated embodiment is oriented with respect to the lock member 12 and the biasing member 38 so that a plane 64 parallel to the lock member axis 16 and extending through a central portion of the actuating member 32 is also extendable through the lock member axis 16 and the biasing member 38.

The actuating member 32 may also be actuated in any suitable manner to cause the engaging members 14 and 15 to move from the locked position to the released position. For example, a force 65 exerted on the actuating member 32 in a direction toward the lock member axis 16 and/or toward the engaging members 14 and 15 (e.g., downward in the embodiment shown in FIGS. 1 and 2), and sufficient to overcome the biasing force of the biasing member 38, may cause the actuating member 32 to move from the first position toward the second position (e.g., toward the lock member axis 16) and thereby move the engaging members 14 and 15 from the locked position to the released position. As a more detailed example, a movable support member (such as a pivotable and/or linearly movable boom, mast, tube, column, arms, etc.) of a lift device or lift may be configured to exert such a force on the actuating member 32 when the lift is in a lowered position, and the support member may be configured to stop applying the force on the actuating member 32 when the lift moves toward a raised position so that the actuating member 32 may move from the second position, shown in FIG. 2, to the first position, shown in FIG. 1.

In addition, as mentioned above, the actuating member 32 may also be configured to move the engaging members 14 and 15 from the released position, shown in FIG. 2, toward the locked position, shown in FIG. 1. For example, the main body 56 of the actuating member 32 may have an engaging portion 66, such as an end portion, that is configured to engage the first and second engaging members 14 and 15, respectively, when the actuating member 32 moves from the second position, shown in FIG. 2, to the first position, shown in FIG. 1, to cause the first and second engaging members 14 and 15, respectively to move to or toward the locked position shown in FIG. 1. For example, the engaging portion 66 may be engageable with an intermediate surface 68 of each engaging member 14, 15 when the actuating member 32 moves from the second position, shown in FIG. 2, to the first position, shown in FIG. 1. Alternatively or supplementally, the lock mechanism 10 may include a biasing member (not shown), such as a torsion spring, associated with each engaging member 14, 15 (e.g., connected between each engaging member 14, 15 and the support member 20) and configured to urge the engaging members 14 and 15 toward the locked position.

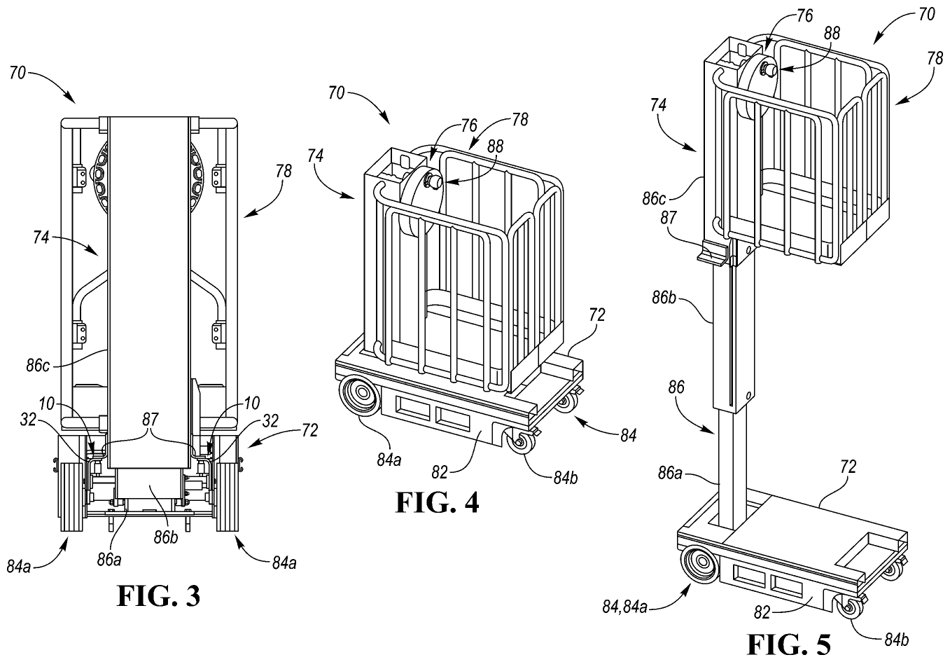

Referring to FIGS. 3-6, an example application for the locking mechanism 10 will now be discussed in more detail. Those figures show an example lift device or lift 70, such as a boom lift or aerial work platform. The lift 70 includes a base 72 on which one or more of the locking mechanisms 10 are mounted, a support member arrangement 74 attached to the base 72, a drive system 76 that is operable to move the support member arrangement 74 between a lowered position, shown in FIGS. 3, 4 and 6, and a raised position, shown in FIG. 5, and a work platform assembly 78 connected to the support member arrangement 74 and configured to receive an operator.

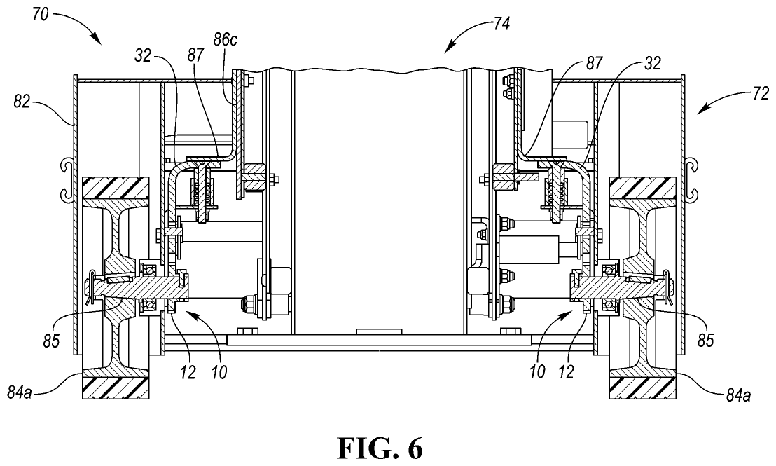

The base 72 of the lift 70 is configured to support the support member arrangement 74, along with the rest of the lift 70, and includes a main body 82, such as a chassis or rigid support structure, and one or more rotatable members or elements 84, such as wheels or casters, attached to the main body 82. In the illustrated embodiment, the lift 70 includes two wheels 84a at a front of the lift 70 and two casters 84b at a rear of the lift 70, and each wheel 84a is mounted on a respective axle 85 as shown in FIG. 6. With this configuration, the lift 70 may be provided with two locking mechanisms 10 according to the disclosure, with one locking mechanism 10 associated with each wheel 84a, as shown in FIGS. 3 and 6. Furthermore, the locking mechanisms 10 are configured to lock the wheels 84a when the lift 70 is moved from the lowered position, shown in FIGS. 3, 4 and 6, to the raised position, shown in FIG. 5.

Referring to FIG. 6, for each locking mechanism 10, the lock member 12 of the locking mechanism 10 is mounted on a respective axle 85, and the engaging members 14 and 15 and the actuating member 32 are movably mounted on the main body 82 of the base 72. For example, each lock member 12 may be fixedly mounted on a respective axle 85 with one or more fasteners, such as a pin, and the engaging members 14 and 15 and the actuating member 32 of each locking mechanism 10 may be movably mounted on a support member (e.g., bracket) that is attached to the main body 82 of the base 72 in any suitable manner, such as with one or more fasteners (e.g., bolts, screws, etc.) and or welds. Furthermore, the actuating member 32 of each locking mechanism 10 is configured to cooperate with the support member arrangement 74, as explained below in detail, in order to move between the first and second positions.

The support member arrangement 74 may include one or more movable support members 86, such as pivotable and/or linearly movable booms, masts, tubes, columns, arms, etc., attached to the base 72. In the embodiment shown in FIGS. 3-6, the support member arrangement 74 includes first, second and third upright support members 86a, 86b and 86c, respectively, and the second and third upright support members 86b and 86c, respectively, are linearly movable with respect to the first upright support member 86a when the support member arrangement 74 moves between the lowered and raise positions. Furthermore, the third upright support member 86c is engageable with the actuating members 32 of the locking mechanisms 10 when the support member arrangement 74 is in the lowered position so that the actuating members 32 are held in the second positions and the locking mechanisms 10 are in the corresponding released positions. For example, the third upright support member 86c may have multiple projections 87 (e.g., brackets) that extend from a main body of the third upright support member 86c so that each projection 87 is engageable with a respective actuating member 32 when the support member arrangement 74 is in the lowered position. When the support member arrangement 74 is moved from the lowered position, shown in FIG. 6, toward the raised position, shown in FIG. 5, sufficient upward movement of the third upright support member 86c may allow each of the actuating members 32 to move from the second position, shown in FIGS. 2 and 6, to the first position, shown in FIG. 1. As a result, each locking mechanism 10 may then move from the released position, shown in FIGS. 2 and 6, to the locked position, shown in FIG. 1, to thereby lock the wheels 84a.

In another embodiment, the second upright support member 86b may be engageable with and disengageable from the actuating members 32 of the locking mechanisms 10 in order to move each locking mechanism 10 between the released position and the locked position. In still yet another embodiment, the support member arrangement 74 may include any suitable number of movable support members 86, wherein one of the movable support members may be engageable with and disengageable from the actuating members 32 of the locking mechanisms 10.

The drive system 76 may have any suitable configuration that is operable to move one or more of the support members 86 in order to move the support member arrangement 74 between the lowered and raised positions. For example, the drive system 76 may include one or more drive members, such as cylinders (e.g., hydraulic and/or electric cylinders), flexible drive members (e.g., strands, belts, chains and/or cables), rigid drive members (e.g., rack and pinion systems, rotatable shafts and gears), etc., and one or more actuators, such as automatic actuators (e.g., electric motors or pumps) and/or manually operable (i.e., hand-operated) actuators. In an embodiment including an automatic actuator, the actuator may be operable to move one or more drive members formed as cylinders between retracted and extended positions, for example. In the embodiment shown in FIGS. 4 and 5, the drive system 76 includes a manually operated actuator 88, which may include a rotatable member, such as a wheel, disc, hand crank, lever arm, etc., that is configured to move one or more drive members, such as through a transmission system including a gear system (not shown). Examples of a lift including a manually operable actuator are disclosed in U.S. application Ser. No. 18/593,237 filed on Mar. 1, 2024, which is hereby incorporated by reference in its entirety.

In another embodiment, a locking mechanism according to the disclosure may include a fixed lock member (e.g., non-rotatable lock member) attached to a fixed component (e.g., non-rotatable component), and first and second engaging members attached to a movable component (e.g. rotatable component), and the engaging members may be cooperable with the lock member in any of the above described manners to inhibit or prevent movement of the movable component relative to the fixed component. For example, the lock member may be fixedly attached to a support member, such as a mast, boom, column, bracket, chassis, or any suitable support body (e.g., rigid body), and the engaging members may be movably attached (e.g., pivotally attached) to a rotatable component, such as a wheel, disc, hand crank, lever arm, etc. that is rotatable about an axis, which may extend through a center of the lock member. Furthermore, the engaging members may be movable with respect to the rotatable component and the lock member between a closed or locked position, to inhibit or prevent rotational movement of the rotatable component in any direction (e.g., clockwise or counterclockwise), and an open or released position, to allow rotation of the rotatable component in any direction. The locking mechanism may also include an actuating member mounted on the rotatable component and configured to move the engaging members between the locked position and/or the released position.

Any of the above-described locking mechanism embodiments according to the disclosure may provide numerous benefits and advantages. For example, any of the above-described embodiments may provide almost instantaneous and positive locking of one component with respect to another. As another example, a relatively large resistive or locking force can be obtained with a relatively minimal actuating force. In addition, any of the above-described embodiments may provide a compact configuration and simple operation.

The following clauses describe aspects of one or more embodiments according to the disclosure.

Clause 1. A locking mechanism according to the disclosure may include a lock member having multiple projections, and first and second engaging members that are each pivotable with respect to the lock member. The first engaging member is engageable with the lock member to inhibit relative rotation between the lock member and the engaging members in a first rotation direction, and the second engaging member is engageable with the lock member to inhibit relative rotation between the lock member and the engaging members in a second rotation direction opposite the first rotation direction. The first and second engaging members may be simultaneously engageable with the lock member to provide a locked condition of the locking mechanism in which the first and second engaging members are each engaged with a respective one of the projections.

Clause 2. The locking mechanism of the preceding clause wherein, when the locking mechanism is in the locked condition, the engaging members are self-locking.

Clause 3. The locking mechanism of any of the preceding clauses wherein the first and second engaging members are each engaged with another respective one of the projections when the locking mechanism is in the locked condition.

Clause 4. The locking mechanism of clause 3 wherein the first and second engaging members each have an end that is engaged with the respective one of the projections and a side portion that is engaged with the another respective one of the projections when the locking mechanism is in the locked condition.

Clause 5. The locking mechanism of any of the preceding clauses wherein the first and second engaging members each have an end that is engaged with the respective one of the teeth when the locking mechanism is in the locked condition, and wherein, for each engaging member, the end is engaged with a side of the respective one of the teeth, and the end has an end surface that is parallel to the side of the respective one of the teeth when the locking mechanism is in the locked condition.

Clause 6. The locking mechanism of clause 5 wherein the first and second engaging members each have a side portion that is engaged with a another respective one of the teeth when the locking mechanism is in the locked condition, and wherein, for each engaging member, the side portion is engaged with a side of the another respective one of the teeth, and the side portion has a side surface that is parallel to the side of the another respective one of the teeth when the locking mechanism is in the locked condition.

Clause 7. The locking mechanism of any of the preceding clauses further comprising an actuation member that is movable between a first position and a second position, wherein the first and second engaging members are each engaged with the respective one of the projections of the lock member when the actuation member is in the first position, and when the actuation member is moved from the first position to the second position, the actuation member causes the first and second engaging members to disengage the lock member.

Clause 8. The locking mechanism of clause 7 further comprising a biasing member that urges the actuation member toward the first position.

Clause 9. The locking mechanism of clause 8 wherein the biasing member comprises a spring.

Clause 10. The locking mechanism of any of clauses 7-9 wherein the lock member has a lock member axis, the first engaging member is pivotable about a first axis, and the first engaging member has an end that is engageable with the lock member, wherein, when the end is engaged with the lock member, a first line extending through the first axis and the end does not pass between the actuation member and the lock member axis.

Clause 11. The locking mechanism of clause 10 wherein the second engaging member is pivotable about a second axis, the second engaging member has an end that is engageable with the lock member, and wherein, when the end of the second engaging member is engaged with the lock member, a second line extending through the second axis and the end of the second engaging member does not pass between the actuation member and the lock member axis.

Clause 12. The locking mechanism of clause 11 wherein the first and second lines are convergeable on a side of the lock member axis opposite the actuation member when the locking mechanism is in the locked condition.

Clause 13. The locking mechanism of any of clauses 7-12 wherein the lock member has a lock member axis, and the actuation member is located closer to the lock member axis when the actuation member is in the second position as compared to when the actuation member is in the first position.

Clause 14. The locking mechanism of any of clauses 7-13 wherein the first engaging member is pivotable about a first axis, the second engaging member is pivotable about a second axis spaced away from the first axis, the first and second engaging members each have an end that is engageable with the lock member, the ends are spaced apart a first distance when the actuation member is in the first position, and the first and second axes are spaced apart a second distance, and wherein the first distance is smaller than the second distance.

Clause 15. The locking mechanism of any of clauses 7-13 wherein the first and second engaging members each have an end that is engageable with the lock member, the ends are spaced apart a first distance when the actuation member is in the first position, and the ends are spaced apart a second distance when the actuation member is in the second position, and wherein the first distance is smaller than the second distance.

Clause 16. The locking mechanism of any of the preceding clauses wherein the first engaging member is pivotable about a first axis, and the second engaging member is pivotable about a second axis spaced away from the first axis.

Clause 17. The locking mechanism of clause 16 further comprising an actuation member that is movable between a first position and a second position, wherein the first and second engaging members are each engaged with the respective one of the projections of the lock member when the actuation member is in the first position, and when the actuation member is moved from the first position to the second position, the actuation member causes the first and second engaging members to disengage the lock member.

Clause 18. The locking mechanism of clause 17 wherein the actuation member has first and second cam surfaces that are engageable with the first and second engaging members, respectively, when the actuation member moves from the first position to the second position to cause the first and second engaging members to disengage the lock member.

Clause 19. The locking mechanism of any of clauses 17-18 wherein the actuation member has an engaging portion that is engageable with the first and second engaging members when the actuation member moves from the second position toward the first position to cause the first and second engaging members to engage the lock member.

Clause 20. A system comprising a rotatable element, and the locking mechanism of any preceding clause, wherein the lock member of the locking mechanism is rotatable with the rotatable element or the engaging members of the locking mechanism are rotatable with the rotatable element, and wherein the lock mechanism is configured to inhibit or prevent rotation of the rotatable element.

Clause 21. A locking mechanism according to the disclosure may comprise a rotatable member having multiple projections, and first and second pivotable engaging members, wherein the first engaging member is engageable with the rotatable member to inhibit rotation of the rotatable member in a first rotation direction, and the second engaging member is engageable with the rotatable member to inhibit rotation of the rotatable member in a second rotation direction opposite the first rotation direction. The locking mechanism may further include an actuation member that is movable between a first position and a second position, wherein the first and second engaging members are each engaged with a respective one of the projections of the rotatable member when the actuation member is in the first position, and when the actuation member is moved from the first position to the second position, the actuation member causes the first and second engaging members to disengage the rotatable member. The locking mechanism may also include a biasing member that urges the actuation member toward the first position.

Clause 22. Any of the preceding clauses 1-21 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A locking mechanism comprising:
a lock member having multiple projections; and
first and second engaging members that are each pivotable with respect to the lock member, wherein the first engaging member is engageable with the lock member to inhibit relative rotation between the lock member and the engaging members in a first rotation direction, and the second engaging member is engageable with the lock member to inhibit relative rotation between the lock member and the engaging members in a second rotation direction opposite the first rotation direction, wherein the first and second engaging members are simultaneously engageable with the lock member to provide a locked condition of the locking mechanism in which the first and second engaging members are each engaged with a respective one of the projections.

2. The locking mechanism of claim 1 wherein, when the locking mechanism is in the locked condition, the engaging members are self-locking.

3. The locking mechanism of claim 1 wherein the first and second engaging members are each engaged with another respective one of the projections when the locking mechanism is in the locked condition.

4. The locking mechanism of claim 3 wherein the first and second engaging members each have an end that is engaged with the respective one of the projections and a side portion that is engaged with the another respective one of the projections when the locking mechanism is in the locked condition.

5. The locking mechanism of claim 1 wherein the first and second engaging members each have an end that is engaged with the respective one of the teeth when the locking mechanism is in the locked condition, and wherein, for each engaging member, the end is engaged with a side of the respective one of the teeth, and the end has an end surface that is parallel to the side of the respective one of the teeth when the locking mechanism is in the locked condition.

6. The locking mechanism of claim 5 wherein the first and second engaging members each have a side portion that is engaged with a another respective one of the teeth when the locking mechanism is in the locked condition, and wherein, for each engaging member, the side portion is engaged with a side of the another respective one of the teeth, and the side portion has a side surface that is parallel to the side of the another respective one of the teeth when the locking mechanism is in the locked condition.

7. The locking mechanism of claim 1 further comprising an actuation member that is movable between a first position and a second position, wherein the first and second engaging members are each engaged with the respective one of the projections of the lock member when the actuation member is in the first position, and when the actuation member is moved from the first position to the second position, the actuation member causes the first and second engaging members to disengage the lock member.

8. The locking mechanism of claim 7 further comprising a biasing member that urges the actuation member toward the first position.

9. The locking mechanism of claim 8 wherein the biasing member comprises a spring.

10. The locking mechanism of claim 7 wherein the lock member has a lock member axis, the first engaging member is pivotable about a first axis, and the first engaging member has an end that is engageable with the lock member, wherein, when the end is engaged with the lock member, a first line extending through the first axis and the end does not pass between the actuation member and the lock member axis.

11. The locking mechanism of claim 10 wherein the second engaging member is pivotable about a second axis, the second engaging member has an end that is engageable with the lock member, and wherein, when the end of the second engaging member is engaged with the lock member, a second line extending through the second axis and the end of the second engaging member does not pass between the actuation member and the lock member axis.

12. The locking mechanism of claim 11 wherein the first and second lines are convergeable on a side of the lock member axis opposite the actuation member when the locking mechanism is in the locked condition.

13. The locking mechanism of claim 7 wherein the lock member has a lock member axis, and the actuation member is located closer to the lock member axis when the actuation member is in the second position as compared to when the actuation member is in the first position.

14. The locking mechanism of claim 13 wherein the first engaging member is pivotable about a first axis, the second engaging member is pivotable about a second axis spaced away from the first axis, the first and second engaging members each have an end that is engageable with the lock member, the ends are spaced apart a first distance when the actuation member is in the first position, and the first and second axes are spaced apart a second distance, and wherein the first distance is smaller than the second distance.

15. The locking mechanism of claim 13 wherein the first and second engaging members each have an end that is engageable with the lock member, the ends are spaced apart a first distance when the actuation member is in the first position, and the ends are spaced apart a second distance when the actuation member is in the second position, and wherein the first distance is smaller than the second distance.

16. The locking mechanism of claim 1 wherein the first engaging member is pivotable about a first axis, and the second engaging member is pivotable about a second axis spaced away from the first axis.

17. The locking mechanism of claim 16 further comprising an actuation member that is movable between a first position and a second position, wherein the first and second engaging members are each engaged with the respective one of the projections of the lock member when the actuation member is in the first position, and when the actuation member is moved from the first position to the second position, the actuation member causes the first and second engaging members to disengage the lock member.

18. The locking mechanism of claim 17 wherein the actuation member has first and second cam surfaces that are engageable with the first and second engaging members, respectively, when the actuation member moves from the first position to the second position to cause the first and second engaging members to disengage the lock member.

19. The locking mechanism of claim 17 wherein the actuation member has an engaging portion that is engageable with the first and second engaging members when the actuation member moves from the second position toward the first position to cause the first and second engaging members to engage the lock member.

20. A system comprising:
a rotatable element; and
the locking mechanism of claim 1, wherein the lock member of the locking mechanism is rotatable with the rotatable element or the engaging members of the locking mechanism are rotatable with the rotatable element, and wherein the lock mechanism is configured to inhibit or prevent rotation of the rotatable element.

21. A locking mechanism comprising:
a rotatable member having multiple projections;
first and second pivotable engaging members, wherein the first engaging member is engageable with the rotatable member to inhibit rotation of the rotatable member in a first rotation direction, and the second engaging member is engageable with the rotatable member to inhibit rotation of the rotatable member in a second rotation direction opposite the first rotation direction;
an actuation member that is movable between a first position and a second position, wherein the first and second engaging members are each engaged with a respective one of the projections of the rotatable member when the actuation member is in the first position, and when the actuation member is moved from the first position to the second position, the actuation member causes the first and second engaging members to disengage the rotatable member; and
a biasing member that urges the actuation member toward the first position.
